(19) United States
(12) Patent Application Publication
(10) Pub. No.: US 2018/0100211 A1
(43) Pub. Date: Apr. 12, 2018

(54) MICROALLOY CARBON STEEL FOR PASSENGER CAR HUB BEARINGS AND METHOD FOR MANUFACTURING THE SAME

(71) Applicant: JIANGYIN XINGCHENG SPECIAL STEEL WORKS CO., LTD., Jiangyin (CN)

(72) Inventors: Min CHEN, Jiangyin (CN); Feng LI, Jiangyin (CN); Qing YIN, Jiangyin (CN); Jiaolong ZHAI, Jiangyin (CN); Ke GENG, Jiangyin (CN); Jianfeng ZHANG, Jiangyin (CN); Zhen HUANG, Jiangyin (CN); Jian BAO, Jiangyin (CN); Xiaojiang RUAN, Jiangyin (CN)

(21) Appl. No.: 15/836,895

(22) Filed: Dec. 10, 2017

Related U.S. Application Data
(63) Continuation-in-part of application No. PCT/CN2016/079010, filed on Apr. 12, 2016.

(30) Foreign Application Priority Data
Jan. 5, 2016 (CN) 201610001624.4

(51) Int. Cl. C21D 9/40; B21B 1/22; C21D 8/06; C21D 6/00; C22C 38/44; C22C 38/04; C22C 38/06; C22C 38/02; C22C 38/00; C22C 38/42; C22C 38/60; C22C 38/50

(52) U.S. Cl. CPC C21D 9/40; B60B 27/02; C21D 8/065; C21D 6/004; C21D 6/005; C21D 6/008; C22C 38/44; C22C 38/04; C22C 38/06; C22C 38/02; C22C 38/002; C22C 38/42; C22C 38/008; C22C 38/60; C22C 38/50; B21B 2001/225; B21B 1/22

(57) ABSTRACT

A steel, including: between 0.45 and 0.70 wt. % of carbon, between 0.10 and 0.50 wt. % of silicon, between 0.30 and 0.70 wt. % of manganese, between 0.20 and 0.60 wt. % of chromium, less than or equal to 0.025 wt. % of phosphorus, between 0.003 and 0.030 wt. % of sulfur, less than or equal to 0.1 wt. % of molybdenum, less than or equal to 0.2 wt. % of nickel, less than or equal to 0.04 wt. % of aluminum, less than or equal to 0.3 wt. % of copper, less than or equal to 0.001 wt. % of calcium, less than or equal to 0.003 wt. % of titanium, less than or equal to 0.001 wt. % of oxygen, less than or equal to 0.04 wt. % of arsenic, less than or equal to 0.03 wt. % of tin.

### CROSS-REFERENCE TO RELATED APPLICATIONS

This application is a continuation-in-part of International Patent Application No. PCT/CN2016/079010 with an international filing date of Apr. 12, 2016, designating the United States, now pending, and further claims foreign priority to Chinese Patent Application No. 201610001624.4 filed Jan. 5, 2016. The contents of all of the aforementioned applications, including any intervening amendments thereto, are incorporated herein by reference.

### BACKGROUND OF THE INVENTION

### Field of the Invention

The invention relates to metallurgy of special steel, in particular for passenger car carbon hub bearings, and a method for manufacturing the steel.

### Description of the Related Art

Hub bearings are important for load bearing and accurate guidance, so the steel used for making hub bearings must have high fatigue strength, high elastic strength, high yield strength and high toughness. Existing steel contains a relatively large amount of nonmetal inclusions, and in the presence of alternating stress, the inclusions cause stress concentration and fatigue cracks, reducing the life time of the hubs. In addition, the phenomenon of central carbon segregation, adversely affects the structure uniformity and the properties of the steel.

### SUMMARY OF THE INVENTION

In view of the above-described problems, it is one objective of the invention to provide a steel for hub bearings. The chemical compositions of the steel are appropriately formulated, and the strength, hardness, toughness, abrasive resistance and hardenability of the steel satisfy the requirement for manufacturing the hub bearings.

Non-metallic inclusions in the steel are listed in Table 1:

TABLE 1

| | Type | | | | | | | | |
|---|---|---|---|---|---|---|---|---|---|
| | A | | B | | C | | D | | |
| | Thin | Thick | Thin | Thick | Thin | Thick | Thin | Thick | DS |
| Level | 2.0 | 1.5 | 1.5 | 0.5 | 0 | 0 | 1.0 | 0.5 | 1.0 |

Test results according to ISO 4967 A show that the maximums of all the non-metallic inclusions are lower than the values in Table 1.

Macroscopic defects of the steel are detected according to the high-frequency impregnating flaw detection method (impregnating ultrasonic method testing purity of forged steel), and a length of single inclusion is less than or equal to 3 mm.

Carbon content tested at a central carbon segregation area of the steel is less than or equal to 10% of normal carbon content of smelted steel, which is far less compared to the central carbon segregation in the prior art.

To achieve the above objective, in accordance with one embodiment of the invention, there is provided a steel for hub bearing, comprising: between 0.45 and 0.70 wt. % of carbon, between 0.10 and 0.50 wt. % of silicon, between 0.30 and 0.70 wt. % of manganese, between 0.20 and 0.60 wt. % of chromium, less than or equal to 0.025 wt. % of phosphorus, between 0.003 and 0.030 wt. % of sulfur, less than or equal to 0.1 wt. % of molybdenum, less than or equal to 0.2 wt. % of nickel, less than or equal to 0.04 wt. % of aluminum, less than or equal to 0.3 wt. % of copper, less than or equal to 0.001 wt. % of calcium, less than or equal to 0.003 wt. % of titanium, less than or equal to 0.001 wt. % of oxygen, less than or equal to 0.04 wt. % of arsenic, less than or equal to 0.03 wt. % of tin, less than or equal to 0.005 wt. % of antimony, and less than or equal to 0.002 wt. % of lead. The rest is iron and inevitable inclusions.

Chemical compositions of the steel are formulated according to the following principles:

1) Determination of Carbon Content

Carbon is the most economical and the most fundamental strengthening element in the steel, and carbon can obviously improve the strength of the steel via solid solution strengthening and precipitation strengthening. However, too much carbon tends to adversely affect the toughness and ductility of the steel, therefore, carbon is determined to be between 0.45 and 0.70 wt. % of the steel, and the steel in the embodiments of the invention belongs to medium carbon steel.

2) Determination of Silicon Content

Silicon is added to the steel to strengthen ferrite, and improve strength, elastic limit, and hardenability of the steel. However, silicon also increases the overheating sensitivity and the possibilities of crack and decarburization, therefore, silicon is determined to be between 0.10 and 0.50 wt. % of the steel in the embodiments of the invention.

3) Determination of Manganese Content

Manganese works as a deoxidizing element during the steelmaking process and can improve the hardenability of steel. Meanwhile, manganese fixes sulfur in the steel and forms MnS and (Fe, Mn)S which do less harm to the properties of steel, and FeS is reduced or avoided. Therefore, steel comprises between 0.10 and 0.70 wt. % of manganese to improve the purity and properties of the steel. However, too much manganese tends to cause obvious temper brittlement, in addition, manganese helps the grain grow, which increases the overheating sensitivity and the possibility of crack, meanwhile, manganese decreases the dimensional stability of steel, resulting in negative influence. Too much manganese also weakens steel resistance to corrosion and affects the performance of the hub bearing. Existing domestic and foreign steel for hub bearing (such as G55, C56E2, etc.) generally comprises between 0.70 and 0.90 wt. % of manganese, and manganese is actually controlled to be about 0.80 wt. % of steel. The manganese content is relatively high, resulting in cracks on the steel surface, tendency of cracking during forging, adverse effect on the use, and shorter service life of the hub bearing. In view of the above problems, certain amount of manganese element is added to the steel so as to reserve the favorable factors including improved hardenability and purity of the steel, meanwhile, the manganese content cannot be too high so as to minimize the adverse influence of manganese, therefore, manganese is determined to be between 0.30 and 0.70 wt. % of the steel in the embodiments of the invention.

4) Determination of Chromium Content

Chromium is a carbide forming element, and works to improve hardenability, abrasive resistance, and corrosion resistance of the steel. One part of chromium in the steel displaces iron to form alloy cementite, and improves the tempering stability of steel, and the other part of chromium is dissolved in the ferrite to improve the strength and hardness of the ferrite via solution strengthening. In addition, chromium also reduces the overheat tendency and the rate of surface decarburization of the steel. However, when the chromium content is too high, chromium is combined with carbon in the steel and forms bulky carbide which decreases the ductility of the steel, and reduces the service life of the hub bearing. Meanwhile, too much chromium results in too high hardness of the steel to meet the requirement of clients (the clients generally require the hardness of the steel to be less than or equal to 255 HBW). Chromium, as a residual element, is less than or equal to 0.2 wt. % in existing domestic and foreign steel for hub bearing, and is not specially added, but considering that chromium improves the strength, hardness, abrasive resistance, and corrosion resistance of the steel, prolongs the service life of hub bearing, and reduces the adverse influence of low manganese content on the hardenability of the steel, chromium element is added in the steel in the embodiments of the invention. Too much chromium results in high hardness of the steel, causes difficulty to process the steel, and forms indissolvable carbide, therefore, according to the manganese content, chromium is determined to be between 0.20 and 0.60 wt. % of the steel in the embodiments of the invention.

5) Determination of Aluminum Content

Aluminum works as a deoxidizing element of steel, and decreases amount of dissolved oxygen in molten steel. Aluminum and nitrogen form dispersed and thin aluminum nitride inclusion which can refine grain. However, during smelting process of steel, too much aluminum produces brittle inclusions including Al₂O₃ which affects the purity of molten steel, therefore, aluminum is determined to be less than or equal to 0.04 wt. % of the steel in the embodiments of the invention.

6) Determination of Calcium Content

Calcium tends to increase size and amount of large-size punctate oxide in the steel. Due to high hardness and poor plasticity of the punctate oxide, the punctate oxide is undeformed when the steel is being processed, and forms clearance at the interface, which adversely affects the performance of the steel. Therefore, calcium is determined to be less than or equal to 0.001 wt. % of the steel in the embodiments of the invention.

7) Determination of Titanium Content

Titanium forms titanium nitride and titanium carbonitride inclusions in the steel. The inclusions are hard and angular, and seriously influence the fatigue life of the hub bearing. Especially when the purity of steel is high, and other oxide inclusions are small in number, the titanium inclusions become a prominent problem. The titanium inclusions decrease the fatigue life of hub bearing, and also affect the coarseness of the hub bearing, therefore, titanium is determined to be less than or equal to 0.003 wt. % of the steel in the embodiments of the invention.

8) Determination of Oxygen Content

A lot of experiments indicated that decreasing the oxygen content is obviously beneficial for the improvement of fatigue life of the hub bearing, therefore, oxygen is determined to be less than or equal to 0.001 wt. % of the steel in the embodiments of the invention.

9) Determination of Phosphorus Content and Sulfur Content

Phosphorus causes segregation during steel solidification. In addition, phosphorus dissolved in ferrite tends to distort and coarsen the grain, and increase the cold brittleness of the steel, therefore, phosphorus is determined to be less than or equal to 0.025 wt. % of the steel. Sulfur increases hot brittleness of steel, and decreases the ductility and toughness of steel, but certain amount of sulfur improves machinability of steel, therefore, sulfur is determined to be between 0.003 and 0.03 wt. % of the steel in the embodiments of the invention.

10) Determination of Arsenic Content, Tin Content, Antimony Content and Lead Content

Microelements including arsenic, tin, antimony, and lead in the steel are low-melting nonferrous metal. Microelements produces soft points on the surface of hub bearing, and results in uneven hardness, therefore, microelements are harmful elements in the steel, and the steel is determined to comprise less than or equal to 0.04 wt. % of arsenic, less than or equal to 0.03 wt. % of tin, less than or equal to 0.005 wt. % of antimony, and less than or equal to 0.002 wt. % of lead.

A method for manufacturing the steel for hub bearing comprises: smelting steel in an electric furnace or a converter; refining the steel; performing vacuum degassing or Ruhrstahl Heraeus (RH) vacuum degassing; continuously casting the steel; continuously rolling the steel; sawing the steel; stacking and cooling the steel; finishing the steel; detecting defects on a steel surface and inside the steel; packaging the steel. The steps are detailed as follows:

Hot metal, scrap, additives, deoxidant, refractory, and other raw materials used in the method are in high quality. When the steel is smelted in the electric furnace or a converter, carbon content at tapping of the electric furnace or the converter is controlled to be higher than or equal to 0.10 wt. %; phosphorus content at the tapping of the electric furnace or the converter is controlled to be less than or equal to 0.020 wt. %. Slag tapping is prevented. Quantity of aluminum and iron added to the steel is determined by the carbon content at the output, and aluminum content of a first sample when the first sample arrived at a refining furnace is controlled between 0.040 and 0.070 wt. %.

In the refining process, refining slag is in a ternary slag system, and micro-positive pressure is maintained in the refining furnace. Small amount of flue gas emits from the refining furnace. Argon stiffing is conducted before the first sample is taken so as to form slags in advance. Ensure the accuracy of sampling each time, aiming to regulate the chemical composition to the target composition within two samples. Aluminum and silicon carbide are used to perform combined deoxidation; in the refining slag, (wt. % FeO+wt. % MnO)<1, so as to ensure a satisfactory deoxidation of slags and low content of free oxygen, thereby taking advantage of the ladle furnace. Aluminum content is maintained between 0.025 and 0.045 wt. %, thus avoiding latter oxide formation.

In the vacuum degassing or Ruhrstahl Heraeus (RH) vacuum degassing, processing time is appropriately prolonged to increase agitated gas flow in vacuum, ensure the degassing performance, and remove inclusions; following the vacuum degassing, soft argon blowing is performed to ensure full floating of the inclusions.

The continuous casting is under antioxidant protection. The molten steel stays in the tundish for about 20 min at average. Asbestos washer at the long nozzle is correctly installed. Before use, the argon sealing at the long nozzle is detected so as to ensure the long nozzle is air tight and has proper flow in use. The tundish uses dry vibration mix, and the tundish has to be clean inside before being heated. Tundish stopper is argon blowing stopper, make sure the head of the stopper is airtight. The airtightness of the argon blowing pipeline of the impact zone and the pouring zone, and the accuracy of the argon blowing instrument are detected before pouring. Prior to the pouring of ladle, the argon blowing in the tundish is protected, and secondary oxidation in the pouring is prevented. In the continuous casting, when abnormal conditions including mold level fluctuation happens, the billets are separated, and downgraded. The continuous casting uses both mold electromagnetic stirrer (M-EMS) and final electromagnetic stirrer (F-EMS). Overheat pouring in the continuous casting is under 35° C. Especially by using the F-EMS, the density of the solidification structure of the casting slab is improved, and the central porosity and shrinkage holes of casting slab are effectively controlled, in addition, the secondary dendrite arm spacing is obviously mended, and the center equiaxed crystal ratio is obviously increased; the crystal grains are refined, thus the quality of the casting slab is obviously improved, and the composition segregation is decreased. A 300 mm×340 mm or larger continuous casting billet is yielded.

In the continuous rolling, the continuous casting slab is heated to between 1050 and 1250° C. to perform high-temperature diffusion. The temperature is kept and the continuous casting billet stays in the heating furnace for more than 3 hrs. Scale in the continuous casting billet is removed using high pressurized water; the continuous casting billet is rolled to yield Φ48-100 bars, where a rough rolling start temperature is higher than 950° C., and a finish rolling temperature is higher than 800° C. Following the continuous rolling, the steel is sawed, cooled, straightened, and detected flaw to yield a target product.

Advantages of the steel and the method according to embodiments of the invention are summarized as follows:

1. Chemical compositions are reasonably designed, and intensity, hardness, tenacity, abrasive resistance, and hardenability of the steel are satisfactory. Tensile strength of the steel is higher than or equal to 780 Megapascal. Hardness of the steel is smaller than or equal to 255 HBW. Jominy of the steel satisfies J1.0, J2.0≥60 HRC, J3.0≥58 HRC, and J4.0≥55 HRC.

2. Raw materials and auxiliary materials are strictly controlled, so as to avoid the high content of harmful elements including titanium, calcium, arsenic, tin, lead, and antimony in the prior art.

3. Core technologies including deoxidation and vacuum degassing of the invention decreases oxygen and hydrogen content in the steel to the lowest, thus the number and size of inclusions in the steel are reduced to the world advanced level.

4. The reduction per pass is appropriately arranged in the rolling process, so as to control the shape of segregation area and the density at ¼ D area.

5. The purity of the steel C56XS for hub bearing satisfies the following requirements: Type A thin inclusions are less than or equal to 2.0; Type A thick inclusions are less than or equal to 1.5; Type B thin inclusions are less than or equal to 1.5; Type B thick inclusions are less than or equal to 0.5; Type C thin inclusions and thick inclusions are zero; Type D thin inclusions are less than or equal to 1.0; Type D thick inclusions are less than or equal to 0.5; and Type Ds inclusions are less than or equal to 1.0.Macroscopic defects of the steel are detected according to a high-frequency impregnating flaw detection method SEP 1927, and a length of single inclusion is less than or equal to 3 mm.

### DETAILED DESCRIPTION OF THE EMBODIMENTS

For further illustrating the invention, experiments detailing a steel for hub bearing and a method for manufacturing the steel are described below.

Chemical compositions (wt. %) of the steel for hub bearing in the examples and chemical compositions (wt. %) of steel G55 and steel C56E2 (as a comparison) which are commonly used in the market are shown in Table 2 and Table 3:

TABLE 2

| | Example | C | Si | Mn | P | S | Cr | Mo | Ni | Al |
|---|---|---|---|---|---|---|---|---|---|---|
| Steel | 1 | 0.56 | 0.30 | 0.58 | 0.013 | 0.004 | 0.35 | 0.01 | 0.03 | 0.015 |
| Steel | 2 | 0.57 | 0.28 | 0.59 | 0.011 | 0.004 | 0.35 | 0.02 | 0.04 | 0.017 |
| Steel | 3 | 0.57 | 0.28 | 0.58 | 0.013 | 0.004 | 0.36 | 0.01 | 0.03 | 0.018 |
| Domestic steel G55 | 4 | 0.55 | 0.27 | 0.80 | 0.012 | 0.001 | 0.08 | 0.01 | 0.03 | 0.022 |
| Foreign steel C56E2 | 5 | 0.56 | 0.28 | 0.79 | 0.010 | 0.002 | 0.10 | 0.01 | 0.03 | 0.018 |

TABLE 3

| | Example | Cu | As | Sn | Sb | Pb | Ca | Ti | O |
|---|---|---|---|---|---|---|---|---|---|
| Steel | 1 | 0.06 | 0.0046 | 0.0067 | 0.0011 | 0.001 | 0.0001 | 0.0007 | 0.00058 |
| Steel | 2 | 0.07 | 0.0045 | 0.0067 | 0.0012 | 0.001 | 0.0002 | 0.0008 | 0.00059 |
| Steel | 3 | 0.06 | 0.0043 | 0.0067 | 0.0010 | 0.001 | 0.0001 | 0.0008 | 0.00058 |
| Domestic steel G55 | 4 | 0.05 | 0.0046 | 0.0050 | 0.0013 | 0.001 | 0.0004 | 0.0006 | 0.00057 |
| Foreign steel C56E2 | 5 | 0.06 | 0.0049 | 0.0044 | 0.0013 | 0.001 | 0.0003 | 0.0009 | 0.00062 |

A method for manufacturing the steel for hub bearing comprises: smelting steel in an electric furnace or a converter; refining the steel; performing vacuum degassing or Ruhrstahl Heraeus (RH) vacuum degassing; continuously casting the steel; continuously rolling the steel; sawing the steel; stacking and cooling the steel; finishing the steel; detecting flaw on a steel surface and inside the steel; packaging the steel.

Specifically, molten iron, scrap, deoxidant, refractory, and other raw materials used in the method are in high quality. When the steel is smelted in the electric furnace or a converter, carbon contents at an output of the electric furnace or the converter in the three examples are 0.25wt. %, 0.29 wt. %, and 0.30 wt. %, respectively; phosphorus contents at the output of the electric furnace or the converter of the three examples are0.012wt. %, 0.010 wt. %, and 0.012 wt. %, respectively. Aluminum contents in the steel when the refining process is finished are controlled to be 0.025 wt. %, 0.02 wt. %, and 0.027 wt. %, respectively. The overheating continuous casting is controlled to be at 22° C., 20° C., 21° C. in the examples, respectively. The heating temperature of the continuous rolling is controlled to between 1050 and 1250° C. The temperature is kept and the continuous casting billet stays in the heating furnace for more than 3 hrs. Scale in the continuous casting billet is removed using pressurized water; the continuous casting billet is rolled in a 17-stand continuous rolling mill, where a rough rolling start temperature is higher than 950° C., and a finish rolling temperature is higher than 800° C. Following the continuous rolling, the steel is sawed, cooled, straightened, and detected flaw to yield a target product.

Comparison of mechanical properties of steel in the examples is shown in Table 4:

TABLE 4

| | | Tensile | | End | End | End | End |
|---|---|---|---|---|---|---|---|
| | | strength | Hardness | quenching | quenching | quenching | quenching |
| | Example | (MPA) | (HBW) | J1.0(HRC) | J2.0(HRC) | J3.0(HRC) | J4.0(HRC) |
| Steel | 1 | 835 | 241 | 62 | 61 | 60 | 58 |
| Steel | 2 | 840 | 239 | 62 | 61.5 | 60 | 58 |
| Steel | 3 | 837 | 240 | 62 | 61 | 59.5 | 57 |
| Domestic steel G55 | 4 | 794 | 230 | 61 | 60.5 | 59 | 55 |
| Foreign steel C56E2 | 5 | 805 | 234 | 61 | 60 | 59 | 56 |

As shown in Table 4, in terms of strength, hardness, toughness, abrasive resistance, and hardenability, the steel for hub bearing in the examples of the invention equal to or is slightly better than existing steel for hub bearing.

In addition, carbon content tested at a central carbon segregation area of the steel in the examples is less than 10% of normal carbon content of smelted steel, thus the central carbon segregation is obviously controlled, and the microstructure uniformity of steel is ensured.

Non-metallic inclusions in the steel in the examples meet the requirements in Table 1. Meanwhile, Macroscopic defects of the steel in the examples are detected according to a high-frequency impregnating flaw detection method SEP 1927, and a length of single inclusion is less than or equal to 3 mm.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A steel, comprising:
between 0.45 and 0.70 wt. % of carbon;
between 0.10 and 0.50 wt. % of silicon;
between 0.30 and 0.70 wt. % of manganese;
between 0.20 and 0.60 wt. % of chromium;
less than or equal to 0.025 wt. % of phosphorus;
between 0.003 and 0.030 wt. % of sulfur;
less than or equal to 0.1 wt. % of molybdenum;
less than or equal to 0.2 wt. % of nickel;
less than or equal to 0.04 wt. % of aluminum;
less than or equal to 0.3 wt. % of copper;
less than or equal to 0.001 wt. % of calcium;
less than or equal to 0.003 wt. % of titanium;
less than or equal to 0.001 wt. % of oxygen;
less than or equal to 0.04 wt. % of arsenic;
less than or equal to 0.03 wt. % of tin;
less than or equal to 0.005 wt. % of antimony;
less than or equal to 0.002 wt. % of lead; and
the balance being iron and inclusions.

2. The steel of claim 1, wherein a length of a single inclusion is less than or equal to 3 mm.

3. The steel of claim 1, wherein nonmetallic inclusions in the steel according to ISO 4967 A meet the following requirements: Type A thin inclusions are less than or equal to 2.0; Type A thick inclusions are less than or equal to 1.5; Type B thin inclusions are less than or equal to 1.5; Type B thick inclusions are less than or equal to 0.5; Type C thin inclusions and thick inclusions are zero; Type D thin inclusions are less than or equal to 1.0; Type D thick inclusions are less than or equal to 0.5; and Type Ds inclusions are less than or equal to 1.0.

4. The steel of claim 1, wherein a tensile strength of the steel is higher than or equal to 780 Megapascal; a hardness of the steel is smaller than or equal to 255 HBW. Jominy of the steel salsifies J1.0, J2.0≥60 HRC, J3.0≥58 HRC, and J4.0≥55 HRC.

5. A method for manufacturing steel, the method comprising:
smelting steel in an electric arc furnace or a converter;
refining the steel ladle refining;
performing vacuum degassing or Ruhrstahl Heraeus (RH) vacuum degassing;
continuously casting the steel;
continuously rolling the steel;
sawing the steel;
stacking and cooling the steel;
finishing the steel;
detecting flaw on a steel surface and inside the steel; and
packaging the steel;
wherein
when the steel is smelted in the electric furnace or a converter, carbon content at an output of the electric furnace or the converter is controlled to be higher than or equal to 0.10 wt. %; phosphorus content at the output of the electric furnace or the converter is controlled to be less than or equal to 0.020 wt. %; slag tapping is prevented; quantity of aluminum and iron added to the steel is determined by the carbon content at the output, and aluminum content of a first sample when the first sample arrived at a refining furnace is controlled between 0.040 and 0.070 wt. %;
in the refining process, refining slag is in a ternary slag system, and micro-positive pressure is maintained in the refining furnace; aluminum and silicon carbide are used to perform combined deoxidation; in the refining slag, wt. % FeO+wt. % MnO is less than 1%, and aluminum content is maintained between 0.025 and 0.045 wt. %;
in the vacuum degassing or Ruhrstahl Heraeus (RH) vacuum degassing, processing time is prolonged to increase agitated gas flow in vacuum; following the vacuum degassing, soft argon blowing is performed;
the continuous casting is under antioxidant protection, and yields a 300 mm×340 mm or larger continuous casting billet; and
the continuous casting billet is moved to a heating furnace to be heated to a temperature between 1050 and 1250° C.; the temperature is kept and the continuous casting billet stays in the heating furnace for more than 3 hrs; phosphorus in the continuous casting billet is removed using pressurized water; the continuous casting billet is rolled to yield Φ48-100 bars, wherein a rough rolling start temperature is higher than 950° C., and a finish rolling temperature is higher than 800° C.; following the continuous rolling, the steel is sawed, cooled, straightened, and detected flaw to yield a target product.

6. The method of claim 5, wherein the continuous casting uses both mold electromagnetic stirrer (M-EMS) and final electromagnetic stirrer (F-EMS); especially, electromagnetic stirrers are applied at a final stage of solidification; overheat pouring in the continuous casting is under 35° C.; the steel is cooled in a secondary cooling section, and growth of the continuous casting billet is controlled so that carbon content at a central carbon segregation area is less than or equal to 10% of normal carbon content of smelted steel.

7. The method of claim 5, wherein the steel prepared by the method comprises between 0.45 and 0.70 wt. % of carbon, between 0.10 and 0.50 wt. % of silicon, between 0.30 and 0.70 wt. % of manganese, between 0.20 and 0.60 wt. % of chromium, less than or equal to 0.025 wt. % of phosphorus, between 0.003 and 0.030 wt. % of sulfur, less than or equal to 0.1 wt. % of molybdenum, less than or equal to 0.2 wt. % of nickel, less than or equal to 0.04 wt. % of aluminum, less than or equal to 0.3 wt. % of copper, less than or equal to 0.001 wt. % of calcium, less than or equal to 0.003 wt. % of titanium, less than or equal to 0.001 wt. % of oxygen, less than or equal to 0.04 wt. % of arsenic, less than or equal to 0.03 wt. % of tin, less than or equal to 0.005 wt. % of antimony, and less than or equal to 0.002 wt. % of lead; iron and inclusions.
